(19) United States
(12) Patent Application Publication
(10) Pub. No.: US 2023/0380434 A1
(43) Pub. Date: Nov. 30, 2023

(54) SMOKER

(71) Applicant: Kenneth Wible, Perkiomenville, PA (US)

(72) Inventor: Kenneth Wible, Perkiomenville, PA (US)

(21) Appl. No.: 18/323,585

(22) Filed: May 25, 2023

Related U.S. Application Data
(60) Provisional application No. 63/346,079, filed on May 26, 2022.

(51) Int. Cl. A23B 4/052; A47J 37/06

(52) U.S. Cl. CPC A23B 4/052; A47J 37/06

(57) ABSTRACT

Systems are described for a smoker with multiple cooking chambers capable of cooking at different temperatures with a single shared firebox. A smoker includes a firebox and a plurality of cooking systems. Each cooking system includes a cooking chamber connected to the firebox by a set of conduits, a valve and a smokestack. The set of conduits are configured to supply a flow of air and smoke from the firebox to the cooking chamber. The valve is operably connected to the set of conduits and is configured to adjust the flow of air and smoke to the cooking chamber. The smokestack is connected to the cooking chamber and is configured to allow the flow of air and smoke to exit the cooking chamber.

### BACKGROUND

The smoking of meat (e.g., beef, pork, poultry, fish and the like) as well as other food (e.g., produce, dairy products, nuts, and any other suitable raw and/or prepared food) typically utilizes a firebox, a cooking chamber, and one or more chambers, conduits and the like connecting the firebox to the cooking chamber. These systems allow for the controlled transfer of heat and smoke from the firebox to the cooking chamber, and for the cooking of food (such as meat) within the cooking chamber. Current smokers have a single cooking chamber, which allows for the cooking of food at a single temperature. However, different foods (e.g., different meats, different cuts of meat, different types of food, etc.) often involve cooking at different temperatures. Therefore, in order to properly cook each different food, a separate second smoker may be needed, or a single smoker may be used multiple times (for cooking the different foods at different temperatures) resulting in a longer overall time to cook different foods and an increased burden on the user.

There exists a need for improved technologies in the cooking of food including meats at different temperatures simultaneously.

### SUMMARY

Aspects of the present disclosure relate to a smoker including a firebox and a plurality of cooking systems. Each cooking system of the plurality of cooking systems includes: a cooking chamber connected to the firebox by a set of conduits, a valve and a smokestack. The set of conduits are configured to supply a flow of air and smoke from the firebox to the cooking chamber. The valve is operably connected to the set of conduits and configured to adjust the flow of air and smoke to the cooking chamber. The smokestack is connected to the cooking chamber and configured to allow the flow of air and smoke to exit the cooking chamber.

Aspects of the present disclosure also relate to a smoker including a firebox, a first cooking chamber, a second cooking chamber, a first valve and a second valve. The first cooking chamber is connected to the firebox by a first set of conduits. The first set of conduits is configured to direct a flow of air and smoke from the firebox to the first cooking chamber. The second cooking chamber is connected to the firebox by a second set of conduits. The second set of conduits is configured to direct the flow of air and smoke from the firebox to the second cooking chamber. The first valve and the second valve are operably connected to the respective first set of conduits and the second set of conduits. The first valve and the second valve are configured to independently adjust the flow of air and smoke supplied to the first cooking chamber and the second cooking chamber from the firebox.

Aspects of the present disclosure also relate to smokers with multiple cooking chambers capable of cooking at different temperatures with a single shared firebox. A smoker includes at least two cooking chambers, a firebox, and at least two sets of conduits configured to supply air and smoke from the firebox to the cooking chambers.

### DESCRIPTION OF DRAWINGS

Aspects, features, benefits and advantages of the present disclosure described herein will be apparent with regard to the following description, appended claims, and accompanying drawings where:

FIG. 1A illustrates an overhead view diagram of a smoker comprising two cooking chambers and one firebox in accordance with an aspect of the present disclosure.

FIG. 1B illustrates a front view diagram of the smoker shown in FIG. 1A in accordance with an aspect of the present disclosure.

FIG. 1C illustrates a side view diagram of the smoker shown in FIG. 1A in accordance with an aspect of the present disclosure.

FIG. 1D illustrates an exploded perspective view diagram of the smoker shown in FIG. 1A in accordance with an aspect of the present disclosure.

FIG. 2A illustrates an overhead view diagram of a smoker comprising two cooking chambers and one firebox in accordance with another aspect of the present disclosure.

FIG. 2B illustrates a front view diagram of the smoker shown in FIG. 2A in accordance with an aspect of the present disclosure.

FIG. 2C illustrates a side view diagram of the smoker shown in FIG. 2A in accordance with an aspect of the present disclosure.

FIG. 2D illustrates an exploded perspective view diagram of the smoker shown in FIG. 2A in accordance with an aspect of the present disclosure.

### DETAILED DESCRIPTION

Before the present compositions and methods are described, it is to be understood that the present disclosure is not limited to the particular processes, compositions, or methodologies described, as these may vary. It is also to be understood that the terminology used in the description is for the purpose of describing the particular aspects only, and is not intended to limit the scope of the present disclosure, which will be limited only by the appended claims. Unless defined otherwise, all technical and scientific terms used herein have the same meaning as commonly understood by one of ordinary skill in the art.

Aspects of the present disclosure are directed towards a smoker comprising at least two cooking systems and one firebox operably connected to each of the cooking systems by sets of conduits. The smoker is configured to allow for the use of multiple cooking chambers at different temperatures connected to the same firebox.

In some examples, aspects of the present disclosure are directed to a smoker with multiple cooking chambers capable of cooking at different temperatures with a single shared firebox. In some examples, a smoker may include at least two cooking chambers, a firebox, and at least two sets of conduits configured to supply air and smoke from the firebox to the cooking chambers. In some examples, the smoker may include at least two cooking systems. Each cooking system may include a cooking chamber connected to the firebox by a set of conduits, a first valve operably connected to the set of conduits to adjust the flow of air and smoke to the cooking chamber, and a smokestack connected to the cooking chamber to allow air and smoke to exit the cooking chamber. In some examples, a second valve may be operationally connected to the smokestack of each cooking system. The first and second valves, for each cooking system, may cooperate to facilitate independent and adjustable temperature regulation for each of the cooking systems (that are connected to a same firebox). The configuration (for each cooking system) of the set of conduits together with the first and second valves provide improved control of air flow and total heat transfer from the single firebox through each cooking system. The smoker configurations of the present disclosure provide the ability to create independently adjustable (e.g., higher or lower) air flow among the cooking systems (where air flow is the mechanism to move heat from the firebox to the individual cooking chambers). In this manner, smokers of the present disclosure permit the cooking of different foods at different temperatures, such as cooking pork at 225° F. and chicken at 350° F.

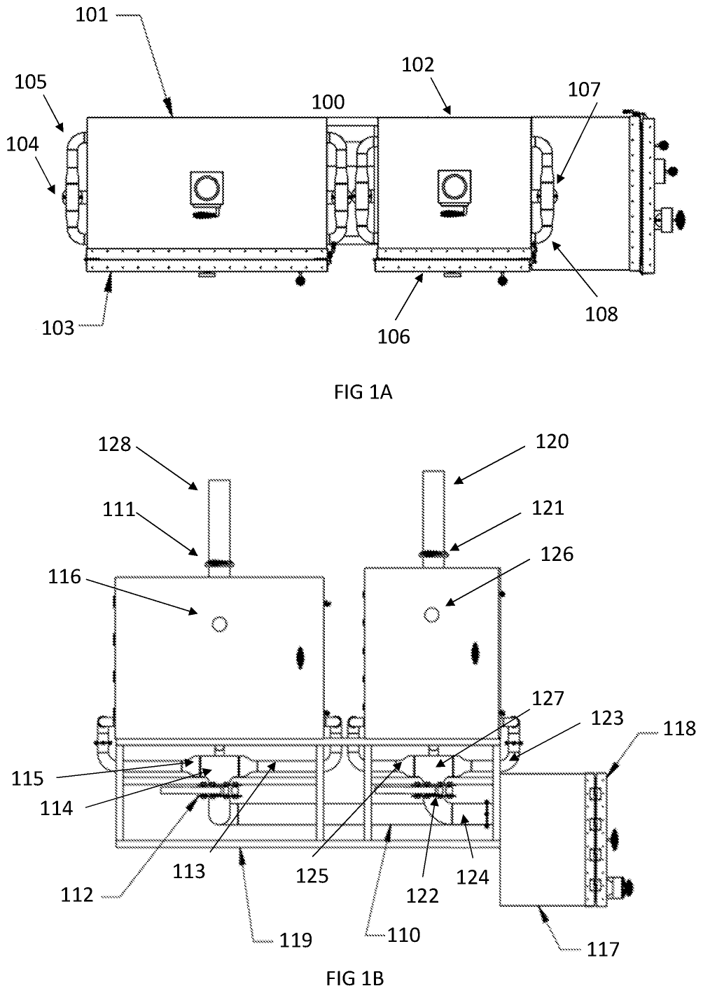

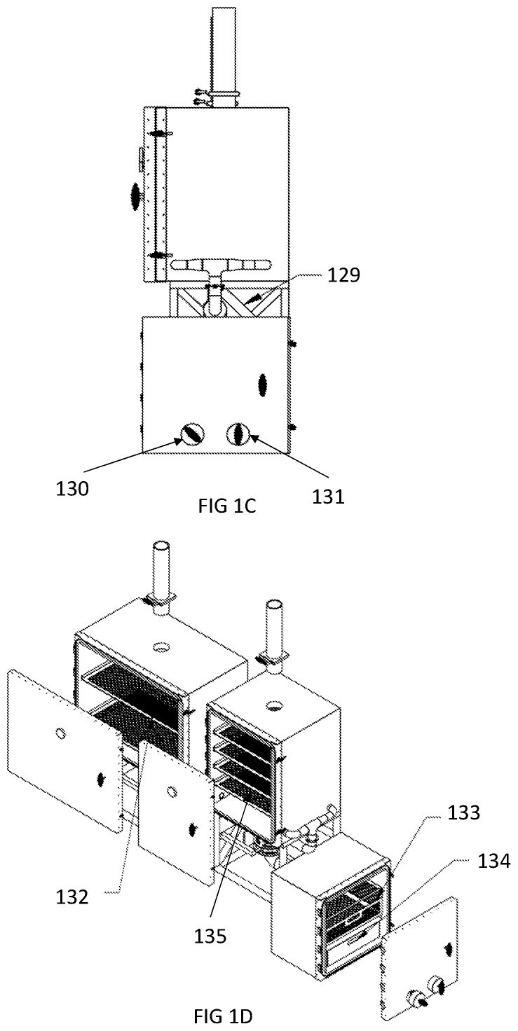

Referring next to FIGS. 1A-1D, smoker 100 is described, in accordance with an aspect of the present disclosure. In particular, FIG. 1A illustrates an overhead view diagram of smoker 100; FIG. 1B illustrates a front view diagram of smoker 100; FIG. 1C illustrates a side view diagram of smoker 100 that illustrates a firebox and a second cooking chamber; and FIG. 1D illustrates an exploded perspective view diagram of smoker 100.

FIGS. 1A-1D illustrate a smoker 100 comprising a firebox 117, a first cooking system including a first cooking chamber 101, and a second cooking system including a second cooking chamber 102. In some examples, the smoker 100 further comprises a frame 119 configured to provide support to each of the cooking systems. In some examples, the firebox 117 is positioned below each of the first cooking chamber 101 and the second cooking chamber 102. In some examples, firebox 117 is positioned adjacent to the one of the first cooking chamber 101 or the second cooking chamber 102. The firebox 117 can be comprised of any suitable material configured to retain heat known to those of ordinary skill in the art. In a non-limiting example, the firebox 117 can be comprised of one or more of stainless steel, steel alloys, aluminum, or cast iron. In some examples, the firebox 117 may further comprise at least one insulation layer configured to retain heat inside the firebox 117. The insulation layer(s) can be comprised of any suitable material known to those of ordinary skill in the art. For example, the insulation layer(s) can be comprised of (without being limited to) one or more of fiberglass, carbon fiber, or ceramic fiber. In a non-limiting example, the insulation layer(s) can have a thickness of about 1 inch, about 2 inches, about 3 inches, or any thickness therebetween.

The firebox 117 comprises a fire tray 133 and an ash tray 134 positioned below the fire tray 133. The fire tray 133 is configured to allow the burning of fuel and the generation of hot air and smoke. The fire tray 133 can be comprised of any suitable material known to those of ordinary skill in the art. In a non-limiting example, the fire tray 133 can be comprised of one or more of stainless steel, steel alloys, aluminum, or cast iron. In some examples, the fire tray 133 can be removed from the firebox 117 to allow for cleaning of the fire tray 133. In some examples, the fire tray 133 is a mesh material configured to allow for ash to fall to the ash tray 134. The ash tray 134 is configured to collect ash and waste from the fire tray 133 during use. In some examples, the ash tray 134 can be removed from the firebox 117 to allow for cleaning of the ash tray 134.

The firebox 117 further comprises a firebox door 118 configured to move from a closed position to an open position. The firebox door 118 is configured to allow for the insertion of fuel onto the fire tray 133 when in the open position. In some examples, the firebox door 118 comprises a plurality of vents configured to promote air and smoke flow into the firebox 117. In some examples, the plurality of vents is positioned below the fire tray 133. In some examples, the firebox door 118 further comprises a slide plate configured to move along the plurality of vents and adjust the flow of air and smoke into the firebox 117. Although FIGS. 1A, 1C and 1D illustrate the firebox 117 as including a single firebox door 118, in some examples, firebox 117 may include at least two firebox doors (e.g., similar to first firebox door 221 and second firebox door 223 of smoker 200, described further below).

The firebox 117 comprises a first pipe outtake and a second pipe outtake. Each pipe outtake is configured to allow air and smoke to exit the firebox 117 and to be supplied to a respective one of two cooking systems. Each of the pipe outtakes are positioned above the fire tray 133. In some examples, each of the pipe outtakes are located on the surface of the firebox 117 opposite the firebox door 118. In some examples, the pipe outtakes are located on the surface of the firebox 117 opposite the firebox door 118 and are positioned directly below the top surface of the firebox 117. In some examples, the outtakes are located on the top surface of the firebox 117.

The smoker 100 comprises a first pipe 110 that is connected to the firebox 117 at the first pipe outtake and a second pipe 124 that is connected to the firebox 117 at the second pipe outtake. The first pipe 110 is configured to supply air and smoke from the firebox 117 to the first cooking chamber 101, and the second pipe 124 is configured to supply air and smoke from the firebox 117 to the second cooking chamber 102. The first pipe 110 can be of any diameter large enough to allow for the flow of air and smoke and heat from the firebox 117 to the first cooking chamber 101. The second pipe 124 can be of any diameter large enough to allow for the flow of air and smoke and heat from the firebox 117 to the second cooking chamber 102. In a non-limiting example, one or both of the first pipe 110 and the second pipe 124 can have a diameter of about 3 inches, about 4 inches, about 5 inches, about 6 inches, about 7 inches, about 8 inches, about 9 inches, about 10 inches, about 11 inches, about 12 inches, or any diameter therebetween.

In some examples, one or both of the first pipe 110 and the second pipe 124 are configured at an angle to assist in the flow of air and smoke from the firebox 117. In some non-limiting examples, one or both of the first pipe 110 and second pipe 124 are configured at an angle of about 1 degree, about 2 degrees, about 3 degrees, about 4 degrees, about 5 degrees, about 6 degrees, about 7 degrees, about 8 degrees, about 9 degrees, about 10 degrees, or any angle therebetween.

The first pipe 110 can be comprised of any suitable material for retaining air and smoke known to those of ordinary skill in the art. For example, the first pipe 110 can be comprised of (without being limited to) one or more of stainless steel, steel alloys, or aluminum. In some examples, the first pipe 110 further comprises at least one insulation layer (e.g., on an outer surface of first pipe 110) configured to retain heat inside the first pipe 110. The insulation layer(s) can be comprised of any suitable material known to those of ordinary skill in the art. For example, insulation layer(s) can be comprised of (without being limited to) one or more of fiberglass, carbon fiber, or ceramic fiber. In a non-limiting example, the insulation layer(s) can have a thickness of about 1 inch, about 2 inches, about 3 inches, or any thickness therebetween.

The second pipe 124 can be comprised of any suitable material for retaining air and smoke known to those of ordinary skill in the art. For example, the second pipe 124 can be comprised of (without being limited to) one or more of stainless steel, steel alloys, or aluminum. In some examples, the second pipe 124 further comprises at least one insulation layer (e.g., on an outer surface of second pipe 124) configured to retain heat inside the second pipe 124. The insulation layer(s) can be comprised of any suitable material known to those of ordinary skill in the art. For example, the insulation layer(s) can be comprised of (without being limited to) one or more of fiberglass, carbon fiber, or ceramic fiber. In a non-limiting example, the insulation layer(s) can have a thickness of about 1 inch, about 2 inches, about 3 inches, or any thickness therebetween.

The smoker 100 comprises a first pipe valve 112 operably connected to the first pipe 110 configured to adjust the flow of air and smoke from the firebox 117 to the first cooking chamber 101 and to regulate the internal temperature of the first cooking chamber 101. The first pipe valve 112 can be any suitable valve known to those of ordinary skill in the art. For example, the first pipe valve 112 can be (without being limited to) a damper valve.

In some examples, the first pipe valve 112 comprises a display to provide the position of the first pipe valve 112, where the position of the first pipe valve 112 is an indication of the amount of air and smoke flow into the first cooking chamber 101. In some examples, the smoker 100 comprises a first user interface device 130, wherein the first user interface device 130 is configured to allow a user to adjust the position of the first pipe valve 112.

The smoker 100 comprises a second pipe valve 122 operably connected to the second pipe 124 configured to adjust the flow of air and smoke from the firebox 117 to the second cooking chamber 102 and to regulate the internal temperature of the second cooking chamber 102. The second pipe valve 122 can be any suitable valve known to those of ordinary skill in the art. For example, the second pipe valve 122 can be (without being limited to) a damper valve.

In some examples, the second pipe valve 122 comprises a display to provide the position of the second pipe valve 122, where the position of the second pipe valve 122 is an indication of the amount of air and smoke flow into the second cooking chamber 102. In some examples, the smoker 100 comprises a second user interface device 131, wherein the second user interface device 131 is configured to allow a user to adjust the position of the second pipe valve 122.

The smoker 100 comprises a first pipe splitter 114 configured to receive air and smoke flow from the first pipe 110 and to allow for the flow of air and smoke in a plurality of directions. In some examples, the first pipe splitter 114 further comprises a first plurality of funnels 115, wherein each of the first plurality of funnels 115 is configured to direct the flow of air and smoke from the first pipe 110 to one of a plurality of first outtake pipes 113. The first plurality of funnels 115 can generally comprise any suitable number of funnels. For example, the first plurality of funnels 115 can comprise, without being limited to, 1, 2, 3, 4, 5, or 6 funnels.

In some examples, the first pipe splitter 114 further comprises a first plurality of sheets configured at an angle to direct air and smoke from the first pipe 110 to the first plurality of funnels 115. In a non-limiting example, the first plurality of sheets is comprised of stainless steel. In some non-limiting examples, each of the first plurality of sheets is configured at an angle of about 1 degree, about 2 degrees, about 3 degrees, about 4 degrees, about 5 degrees, about 6 degrees, about 7 degrees, about 8 degrees, about 9 degrees, about 10 degrees, about 15 degrees, about 20 degrees, about 25 degrees, about 30 degrees, about 35 degrees, about 40 degrees, about 45 degrees, about 50 degrees, about 60 degrees, about 65 degrees, about 70 degrees, or any angle therebetween.

In some examples, each of the first outtake pipes 113 have a smaller diameter than the first pipe 110. In some examples, each of the first outtake pipes 113 have the same diameter. In a non-limiting example, each of the first outtake pipes 113 can have a diameter of about 1 inch, about 2 inches, about 3 inches, about 4 inches, about 5 inches, about 6 inches, or any diameter therebetween. There can generally be any number of first outtake pipes 113. For example, the number of first outtake pipes 113 can be, without being limited to, 1, 2, 3, 4, 5, or 6 pipes.

In some examples, each of the first outtake pipes 113 is configured at an angle to assist in the flow of air and smoke to the first cooking chamber 101. In some non-limiting examples, each of the first outtake pipes 113 is configured at an angle of about 1 degree, about 2 degrees, about 3 degrees, about 4 degrees, about 5 degrees, about 6 degrees, about 7 degrees, about 8 degrees, about 9 degrees, about 10 degrees, or any angle therebetween.

Each of the first outtake pipes 113 can be comprised of any suitable material known to those of ordinary skill in the art. For example, each of the first outtake pipes 113 can be comprised of (without being limited to) one or more of stainless steel, steel alloys, or aluminum. In some examples, each of the first outtake pipes 113 further comprises at least one insulation layer (e.g., on an outer surface) configured to retain heat inside each of the first outtake pipes 113. The insulation layer(s) can be comprised of any suitable material known to those of ordinary skill in the art. For example, the insulation layer(s) can be comprised of (without being limited to) one or more of fiberglass, carbon fiber, or ceramic fiber. In a non-limiting example, the insulation layer(s) can have a thickness of about 1 inch, about 2 inches, about 3 inches, or any thickness therebetween.

The smoker 100 comprises a second pipe splitter 127 configured to receive air and smoke flow from the second pipe 124 and to allow for the flow of air and smoke in a plurality of directions. In some examples, the second pipe splitter 127 further comprises a second plurality of funnels 125, wherein each of the second plurality of funnels 125 is configured to direct the flow of air and smoke from the second pipe 124 to one of a plurality of second outtake pipes 123. The second plurality of funnels 125 can generally comprise any suitable number of funnels. For example, the second plurality of funnels 125 can comprise, without being limited to, 1, 2, 3, 4, 5, or 6 funnels.

In some examples, the second pipe splitter 127 further comprises a second plurality of sheets configured at an angle to direct air and smoke from the second pipe 124 to the second plurality of funnels 125. In a non-limiting example, the second plurality of sheets is comprised of stainless steel. In some non-limiting examples, each of the second plurality of sheets is configured at an angle of about 1 degree, about 2 degrees, about 3 degrees, about 4 degrees, about 5 degrees, about 6 degrees, about 7 degrees, about 8 degrees, about 9 degrees, about 10 degrees, about 15 degrees, about 20 degrees, about 25 degrees, about 30 degrees, about 35 degrees, about 40 degrees, about 45 degrees, about 50 degrees, about 60 degrees, about 65 degrees, about 70 degrees, or any angle therebetween.

In some examples, each of the second outtake pipes 123 have a smaller diameter than the second pipe 124. In some examples, each of the second outtake pipes 123 have the same diameter. In a non-limiting example, each of the second outtake pipes 123 can have a diameter of about 1 inch, about 2 inches, about 3 inches, about 4 inches, about 5 inches, about 6 inches, or any diameter therebetween. There can generally be any number of second outtake pipes 123. For example, the number of second outtake pipes 123 can be, without being limited to, 1, 2, 3, 4, 5, or 6 pipes.

In some examples, each of the second outtake pipes 123 is configured at an angle to assist in the flow of air and smoke to the second cooking chamber 102. In some non-limiting examples, each of the second outtake pipes 123 is configured at an angle of about 1 degree, about 2 degrees, about 3 degrees, about 4 degrees, about 5 degrees, about 6 degrees, about 7 degrees, about 8 degrees, about 9 degrees, about 10 degrees, or any angle therebetween.

Each of the second outtake pipes 123 can be comprised of any suitable material known to those of ordinary skill in the art. For example, each of the second outtake pipes 123 can be comprised of (without being limited to) one or more of stainless steel, steel alloys, or aluminum. In some examples, each of the second outtake pipes 123 further comprises at least one insulation layer (e.g., on an outer surface) configured to retain heat inside each of the second outtake pipes 123. The insulation layer(s) can be comprised of any suitable material known to those of ordinary skill in the art. For example, the insulation layer(s) can be comprised of (without being limited to) one or more of fiberglass, carbon fiber, or ceramic fiber. In a non-limiting example, the insulation layer(s) can have a thickness of about 1 inch, about 2 inches, about 3 inches, or any thickness therebetween.

Each of the first outtake pipes 113 are operably connected to a first outtake pipe splitter 104 configured allow for the flow of air and smoke in a plurality of directions. Each of the first outtake pipe splitters 104 are connected to a plurality of first intake pipes 105.

In some examples, each of the first intake pipes 105 have the same diameter. In a non-limiting example, each of the first intake pipes 105 can have a diameter of about 1 inch, about 2 inches, about 3 inches, about 4 inches, about 5 inches, about 6 inches, or any diameter therebetween. There can generally be any number of first intake pipes 105. For example, the number of first intake pipes 105 can be, without being limited to, 1, 2, 3, 4, 5, or 6 pipes.

In some examples, each of the first intake pipes 105 is configured at an angle to assist in the flow of air and smoke to the second cooking chamber 102. In some non-limiting examples, each of the first intake pipes 105 is configured at an angle of about 1 degree, about 2 degrees, about 3 degrees, about 4 degrees, about 5 degrees, about 6 degrees, about 7 degrees, about 8 degrees, about 9 degrees, about 10 degrees, or any angle therebetween.

Each of the first intake pipes 105 can be comprised of any suitable material known to those of ordinary skill in the art. For example, each of the first intake pipes 105 can be comprised of (without being limited to) one or more of stainless steel, steel alloys, or aluminum. In some examples, each of the first intake pipes 105 further comprises at least one insulation layer (e.g., on an outer surface) configured to retain heat inside each of the first intake pipes 105. The insulation layer(s) can be comprised of any suitable material known to those of ordinary skill in the art. For example, the insulation layer(s) can be comprised of (without being limited to) one or more of fiberglass, carbon fiber, or ceramic fiber. In a non-limiting example, the insulation layer(s) can have a thickness of about 1 inch, about 2 inches, about 3 inches, or any thickness therebetween.

In some examples, each of the first intake pipes 105 is connected to the first cooking chamber 101 at a position adjacent to the bottom surface of the first cooking chamber 101. In some examples, each of the first intake pipes 105 is connected to the first cooking chamber 101 at a position adjacent to each of the bottom corners of the first cooking chamber 101. Through connecting the first intake pipes 105 at each of the bottom corners of the first cooking chamber 101, the first cooking chamber 101 receives an equal amount of air and smoke from the firebox 117 throughout the first cooking chamber 101. This assists in ensuring a uniform temperature throughout the first cooking chamber 101.

Each of the second outtake pipes 123 are operably connected to a second outtake pipe splitter 107 configured allow for the flow of air and smoke in a plurality of directions. Each of the second outtake pipe splitters 107 are connected to a plurality of second intake pipes 108.

In some examples, each of the second intake pipes 108 have the same diameter. In a non-limiting example, each of the second intake pipes 108 can have a diameter of about 1 inch, about 2 inches, about 3 inches, about 4 inches, about 5 inches, about 6 inches, or any diameter therebetween. There can generally be any number of second intake pipes 108. For example, the number of second intake pipes 108 can be, without being limited to, 1, 2, 3, 4, 5, or 6 pipes.

In some examples, each of the second intake pipes 108 is configured at an angle to assist in the flow of air and smoke to the second cooking chamber 102. In some non-limiting examples, each of the second intake pipes 108 is configured at an angle of about 1 degree, about 2 degrees, about 3 degrees, about 4 degrees, about 5 degrees, about 6 degrees, about 7 degrees, about 8 degrees, about 9 degrees, about 10 degrees, or any angle therebetween.

Each of the second intake pipes 108 can be comprised of any suitable material known to those of ordinary skill in the art. For example, each of the second intake pipes 108 can be comprised of (without being limited to) one or more of stainless steel, steel alloys, or aluminum. In some examples, each of the second intake pipes 108 further comprises at least one insulation layer (e.g., on an outer surface) configured to retain heat inside each of the second intake pipes 108. The insulation layer(s) can be comprised of any suitable material known to those of ordinary skill in the art. For example, the insulation layer(s) can be comprised of (without being limited to) one or more of fiberglass, carbon fiber, or ceramic fiber. In a non-limiting example, insulation layer(s) can have a thickness of about 1 inch, about 2 inches, about 3 inches, or any thickness therebetween.

In some examples, each of the second intake pipes 108 is connected to the second cooking chamber 102 at a position adjacent to the bottom surface of the second cooking chamber 102. In some examples, each of the second intake pipes 108 is connected to the second cooking chamber 102 at a position adjacent to each of the bottom corners of the second cooking chamber 102. Through connecting the second intake pipes 108 at each of the bottom corners of the second cooking chamber 102, the second cooking chamber 102 receives an equal amount of air and smoke from the firebox 117 throughout the second cooking chamber 102. This assists in ensuring a uniform temperature throughout the second cooking chamber 102.

The first cooking chamber 101 comprises a first cooking chamber door 103 configured to move from a closed position to an open position. The first cooking chamber door 103 is configured to allow for the insertion of raw food onto one of a first plurality of cooking trays 132 when in the open position. The first cooking chamber 101 can be comprised of any suitable material configured to retain heat known to those of ordinary skill in the art. For example, the first cooking chamber 101 can be comprised of (without being limited to) one or more of stainless steel, steel alloys, aluminum, or cast iron.

The second cooking chamber 102 comprises a second cooking chamber door 106 configured to move from a closed position to an open position. The second cooking chamber door 106 is configured to allow for the insertion of raw food onto one of a second plurality of cooking trays 135 when in the open position. The second cooking chamber 102 can be comprised of any suitable material configured to retain heat known to those of ordinary skill in the art. For example, the second cooking chamber 102 can be comprised of (without being limited to) one or more of stainless steel, steel alloys, aluminum, or cast iron.

In some examples, the first cooking chamber 101 further comprises at least one insulation layer configured to retain heat inside the first cooking chamber 101. In some examples, the first cooking chamber 101 comprises two insulation layers, with one insulation layer positioned on the inner surface of the first cooking chamber 101 and one insulation layer positioned on the outer surface of the first cooking chamber 101. Each of the insulation layer(s) can be comprised of any suitable material known to those of ordinary skill in the art. For example, the insulation layer(s) can be comprised of (without being limited to) one or more of fiberglass, carbon fiber, or ceramic fiber. In a non-limiting example, each of the insulation layer(s) can have a thickness of about 1 inch, about 2 inches, about 3 inches, or any thickness therebetween.

In some examples, the second cooking chamber 102 further comprises at least one insulation layer configured to retain heat inside the second cooking chamber 102. In some examples, the second cooking chamber 102 comprises two insulation layers, with one insulation layer positioned on the inner surface of the second cooking chamber 102 and one insulation layer positioned on the outer surface of the second cooking chamber 102. Each of the insulation layer(s) can be comprised of any suitable material known to those of ordinary skill in the art. For example, the insulation layer(s) can be comprised of (without being limited to) one or more of fiberglass, carbon fiber, or ceramic fiber. In a non-limiting example, each of the at insulation layer(s) can have a thickness of about 1 inch, about 2 inches, about 3 inches, or any thickness therebetween.

The first cooking chamber 101 further comprises at least one thermometer configured to measure at least one temperature inside the first cooking chamber 101. The thermometer(s) may be of any suitable type known to those of ordinary skill in the art. In some examples, the thermometer(s) can be configured to transmit temperature measurements to a display device by a wired or a wireless connection, such as through a network, WiFi, or Bluetooth connection. In some examples, the thermometer(s) is a first temperature gauge 116. In some examples, the first temperature gauge 116 is positioned on the first cooking chamber door 103.

The second cooking chamber 102 further comprises at least one thermometer configured to measure at least one temperature inside the second cooking chamber 102. The thermometer(s) may be of any suitable type known to those of ordinary skill in the art. In some examples, the thermometer(s) can be configured to transmit temperature measurements to a display device by a wired or a wireless connection, such as through a network, WiFi, or Bluetooth connection. In some examples, the thermometer(s) is a second temperature gauge 126. In some examples, the second temperature gauge 126 is positioned on the second cooking chamber door 106.

The first cooking chamber 101 comprises a first plurality of cooking trays 132. In some examples, the first plurality of cooking trays 132 are positioned in vertical rows within the first cooking chamber 101. In some examples, the first plurality of cooking trays 132 can be removed for cleaning. In some examples, the first plurality of cooking trays 132 are configured at an angle to allow for waste, such as grease, to flow off the first plurality of cooking trays 132 to the bottom surface of the first cooking chamber 101. In some examples, the first plurality of cooking trays 132 are comprised of a mesh material configured to allow for waste, such as grease, to fall to the bottom surface of the first cooking chamber 101. The first plurality of cooking trays 132 can be comprised of any suitable material known to those of ordinary skill in the art. For example, the first plurality of cooking trays 132 can be comprised of (without being limited to) one or more of stainless steel, steel alloys, or aluminum.

The second cooking chamber 102 comprises a second plurality of cooking trays 135. In some examples, the second plurality of cooking trays are positioned in vertical rows within the second cooking chamber 102. In some examples, the second plurality of cooking trays 135 can be removed for cleaning. In some examples, the second plurality of cooking trays 135 are configured at an angle to allow for waste, such as grease, to flow off the second plurality of cooking trays 135 to the bottom surface of the second cooking chamber 102. In some examples, the second plurality of cooking trays 135 are comprised of a mesh material configured to allow for waste, such as grease, to fall to the bottom surface of the second cooking chamber 102. The second plurality of cooking trays 135 can be comprised of any suitable material known to those of ordinary skill in the art. For example, the second plurality of cooking trays 135 can be comprised of (without being limited to) one or more of stainless steel, steel alloys, or aluminum.

The first cooking chamber 101 comprises a waste pipe (not shown, but similar to waste pipe 129 shown in FIG. 1C) configured to allow for the removal of waste from the first cooking chamber 101. In some examples, the waste pipe is connected to the bottom surface of the first cooking chamber 101. In some examples, the bottom surface of the first cooking chamber 101 is configured at a slope, wherein the waste pipe is positioned at the bottom of the slope to assist in the removal of waste from the first cooking chamber 101.

The second cooking chamber 102 comprises a waste pipe 129 configured to allow for the removal of waste from the second cooking chamber 102. In some examples, the waste pipe 129 is connected to the bottom surface of the second cooking chamber 102. In some examples, the bottom surface of the second cooking chamber 102 is configured at a slope, wherein the waste pipe 129 is positioned at the bottom of the slope to assist in the removal of waste from the second cooking chamber 102.

The first cooking chamber 101 further comprises a first smokestack 128 configured to remove air and smoke from the first cooking chamber 101. In some examples, the first smokestack 128 is positioned on the top surface of the first cooking chamber 101. In some examples, the first smokestack 128 is positioned in the center of the top surface of the first cooking chamber 101. The combination of positioning the first smokestack 128 in the center of the top surface of first cooking chamber 101 and connecting the first intake pipes 105 at each of the bottom corners of the first cooking chamber 101 provides a flow of air and smoke within first cooking chamber 101. This assists in providing a uniform temperature within the first cooking chamber 101.

The first smokestack 128 comprises a first smokestack valve 111 configured to adjust the flow of air and smoke out of the first cooking chamber 101. Through adjusting the air and smoke flow out of the first cooking chamber 101, the first smokestack valves 111 assists in controlling the internal temperature of the first cooking chamber 101. The first smokestack valve 111 can be any suitable valve known to those of ordinary skill in the art. In a non-limiting example, the first smokestack valve 111 can be a damper valve.

In some examples, the first smokestack valve 111 comprises a display to provide the position of the first smokestack valve 111, where the position of the first smokestack valve 111 is an indication of the amount of air and smoke flow out of the first cooking chamber 101. In some examples, the first smokestack valve 111 comprise a user interface device configured to allow a user to adjust the position of the first smokestack valve 111.

The second cooking chamber 102 further comprises a second smokestack 120 configured to remove air and smoke from the second cooking chamber 102. In some examples, the second smokestack 120 is positioned on the top surface of the second cooking chamber 102. In some examples, the second smokestack 120 is positioned in the center of the top surface of the second cooking chamber 102. The combination of positioning the second smokestack 120 in the center of the top surface of second cooking chamber 102 and connecting the second intake pipes 108 at each of the bottom corners of the second cooking chamber 102 provides a flow of air and smoke within second cooking chamber 102. This assists in providing a uniform temperature within the second cooking chamber 102.

The second smokestack 120 comprises a second smokestack valve 121 configured to adjust the flow of air and smoke out of the second cooking chamber 102. Through adjusting the air and smoke flow out of the second cooking chamber 102, the second smokestack valve 121 assists in controlling the internal temperature of the second cooking chamber 102. The second smokestack valve 121 can be any suitable valve known to those of ordinary skill in the art. In a non-limiting example, the second smokestack valve 121 can be a damper valve.

In some examples, the second smokestack valve 121 comprises a display to provide the position of the second smokestack valve 121, where the position of the second smokestack valve 121 is an indication of the amount of air and smoke flow out of the second cooking chamber 102. In some examples, the second smokestack valve 121 comprise a user interface device configured to allow a user to adjust the position of the second smokestack valve 121.

In some examples, the first pipe 110, the first pipe splitter 114, the first plurality of funnels 115, the plurality of first outtake pipes 113, the first outtake pipe splitters 104 and the plurality of first intake pipes 105 may form a first set of conduits configured to supply a flow of air and smoke from the firebox 117 to the first cooking chamber 101. Similarly, the second pipe 124, the second pipe splitter 127, the second plurality of funnels 125, the plurality of second outtake pipes 123, the second outtake pipe splitters 107 and the plurality of second intake pipes 108 may form a second set of conduits configured to supply a flow of air and smoke from the firebox 117 to the second cooking chamber 102.

In some examples, smoker 100 may include two cooking systems. The first cooking system may include the first cooking chamber 101, the first smokestack 128, the first set of conduits (between the first cooking chamber 101 and the firebox 117) together with the first pipe valve 112 and the first smokestack valve 111. In some examples, the combination of the first pipe valve 112 and the first smokestack valve 111 may be configured to facilitate adjustable internal temperature regulation of the first cooking chamber 101. Similarly, the second cooking system may include the second cooking chamber 102, the second smokestack 120, the second set of conduits (between the second cooking chamber 102 and the firebox 117) together with the second pipe valve 122 and the second smokestack valve 121. In some examples, the combination of the second pipe valve 122 and the second smokestack valve 121 may be configured to facilitate adjustable internal temperature regulation of the second cooking chamber 102. In this manner, the first combination of the first pipe valve 112, the first smokestack valve 111 and first temperature gauge 116 together with the second combination of the second pipe valve 122, the second smokestack valve 121 and the second temperature gauge 126 cooperate to facilitate independent and adjustable temperature regulation for each of the first and second cooking systems.

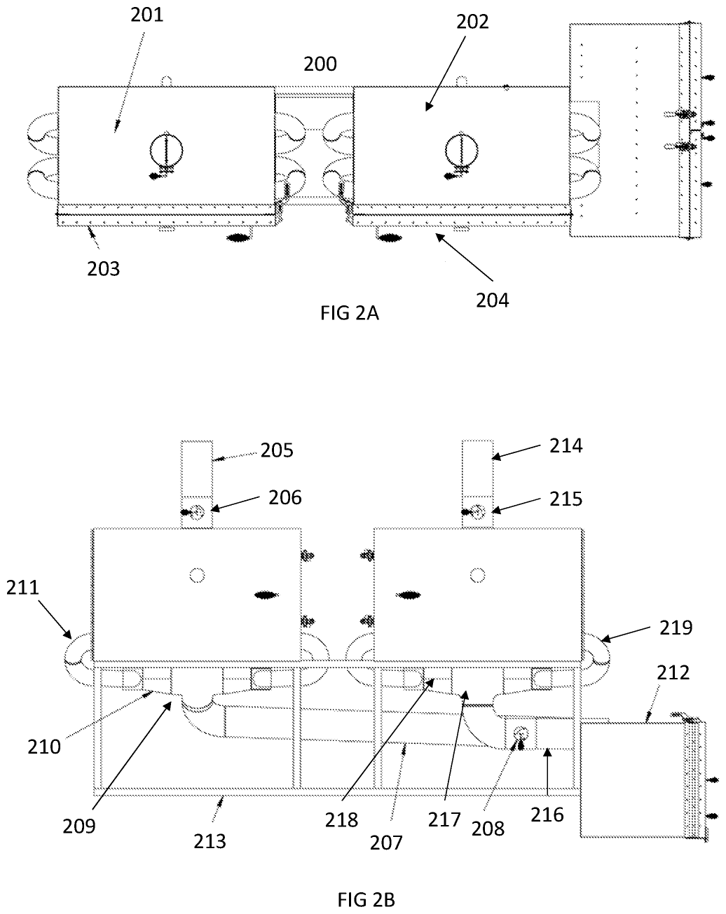

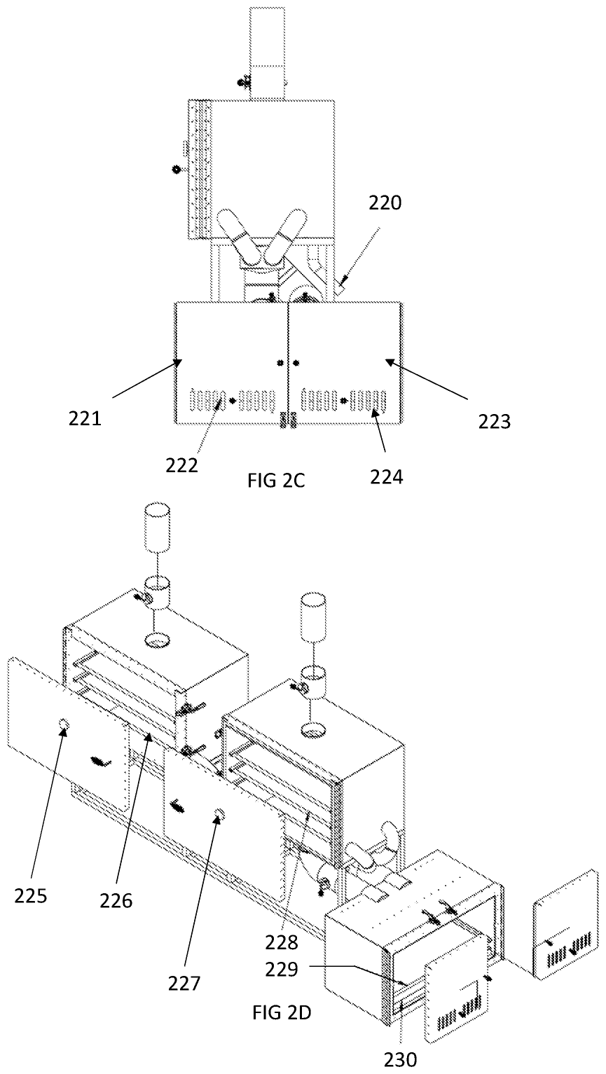

In some examples, smoker 100 may include two cooking chambers (i.e., the first cooking chamber 101 and the second cooking chamber 102), where the two cooking chambers are configured to have different sizes. For example, as shown best in FIGS. 1A, 1B and 1D, the first cooking chamber 101 is larger than (i.e., has a greater internal volume) the second cooking chamber 102. In some examples, each cooking chamber (e.g., the first cooking chamber 101 and the second cooking chamber 102) may be configured to be of a similar and/or a same size (e.g., as illustrated by the first cooking chamber 201 and the second cooking chamber 202 of smoker 200, shown best in FIGS. 2A, 2B and 2D). Although FIGS. 1A-1D illustrate two cooking chambers, smoker 100 is not so limited and may include, in some examples, more than two cooking chambers (e.g., by incorporating a suitable set of conduits), to thereby provide more than two cooking systems.

Referring next to FIGS. 2A-2D, smoker 200 is described, in accordance with another aspect of the present disclosure. In particular, FIG. 2A illustrates an overhead view diagram of smoker 200; FIG. 2B illustrates a front view diagram of smoker 200; FIG. 2C illustrates a side view diagram of smoker 200 that illustrates a firebox and a second cooking chamber; and FIG. 2D illustrates an exploded perspective view diagram of smoker 200.

FIGS. 2A-2D illustrate a smoker 200 comprising a firebox 212, a first cooking system including a first cooking chamber 201, and a second cooking system including a second cooking chamber 202. In some examples, the smoker 200 further comprises a frame 213 configured to provide support to each of the cooking systems. In some examples, the firebox 212 is positioned below each of the first cooking chamber 201 and second cooking chamber 202. In some examples, firebox 212 is positioned adjacent to the one of the first cooking chamber 201 or the second cooking chamber 202. The firebox 212 can be comprised of any suitable material configured to retain heat known to those of ordinary skill in the art. In a non-limiting example, the firebox 212 can be comprised of one or more of stainless steel, steel alloys, aluminum, or cast iron. In some examples, the firebox 212 may further comprise at least one insulation layer configured to retain heat inside the firebox 212. The insulation layer(s) can be comprised of any suitable material known to those of ordinary skill in the art. For example, the insulation layer(s) can be comprised of (without being limited to) one or more of fiberglass, carbon fiber, or ceramic fiber. In a non-limiting example, the insulation layer(s) can have a thickness of about 1 inch, about 2 inches, about 3 inches, or any thickness therebetween.

The firebox 212 comprises a fire tray 229 and an ash tray 230 positioned below the fire tray 229. The fire tray 229 is configured to allow the burning of fuel and the generation of hot air and smoke. The fire tray 229 can be comprised of any suitable material known to those of ordinary skill in the art. In a non-limiting example, the fire tray 229 can be comprised of one or more of stainless steel, steel alloys, aluminum, or cast iron. In some examples, the fire tray 229 can be removed from the firebox 212 to allow for cleaning of the fire tray 229. In some examples, the fire tray 229 is a mesh material configured to allow for ash to fall to the ash tray 230. The ash tray 230 is configured to collect ash and waste from the fire tray 229 during use. In some examples, the ash tray 230 can be removed from the firebox 212 to allow for cleaning of the ash tray 230.

The firebox 212 further comprises a first firebox door 221 and a second firebox door 223 configured to move from a closed position to an open position. Each of the first firebox door 221 and second firebox door 223 are configured to allow for the insertion of fuel onto the fire tray 229 when in the open position. In some examples, the first firebox door 221 comprises a first plurality of vents 222 configured to promote air and smoke flow into the firebox 212. In some examples, the first plurality of vents 222 is positioned below the fire tray 229. In some examples, the first firebox door 221 further comprises a slide plate configured to move along the first plurality of vents 222 and adjust the flow of air and smoke into the firebox 212. In some examples, the second firebox door 223 comprises a second plurality of vents 224 configured to promote air and smoke flow into the firebox 212. In some examples, the second plurality of vents 224 is positioned below the fire tray 229. In some examples, the second firebox door 223 further comprises a slide plate configured to move along the second plurality of vents 224 and adjust the flow of air and smoke into the firebox 212. Although FIGS. 2A, 2C and 2D illustrate the firebox 212 as including first firebox door 221 and second firebox door 223, in some examples, firebox 212 may include a single firebox door (e.g., similar to firebox door 118 of smoker 100) or may include more than two firebox doors.

The firebox 212 comprises a first pipe outtake and a second pipe outtake. Each pipe outtake is configured to allow air and smoke to exit the firebox 212 and to be supplied to a respective one of two cooking systems. Each of the pipe outtakes are positioned above the fire tray 229. In some examples, each of the pipe outtakes are located on the surface of the firebox 212 opposite the first firebox door 221 and second firebox door 223. In some examples, the pipe outtakes are located on the surface of the firebox 212 opposite the first firebox door 221 and second firebox door 223 and are positioned directly below the top surface of the firebox 212. In some examples, the outtakes are located on the top surface of the firebox 212.

The smoker 200 comprises a first pipe 207 that is connected to the firebox 212 at the first pipe outtake and is configured to supply air and smoke from the firebox 212 to the first cooking chamber 201. The first pipe 207 can be of any diameter large enough to allow for the flow of air and smoke and heat from the firebox 212 to the first cooking chamber 201. In a non-limiting example, the first pipe 207 can have a diameter of about 3 inches, about 4 inches, about 5 inches, about 6 inches, about 7 inches, about 8 inches, about 9 inches, about 10 inches, about 11 inches, about 12 inches, or any diameter therebetween.

In some examples, the first pipe 207 is configured at an angle to assist in the flow of air and smoke from the firebox 212 to the first cooking chamber 201. In some non-limiting examples, the first pipe 207 is configured at an angle of about 1 degree, about 2 degrees, about 3 degrees, about 4 degrees, about 5 degrees, about 6 degrees, about 7 degrees, about 8 degrees, about 9 degrees, about 10 degrees, or any angle therebetween.

The first pipe 207 can be comprised of any suitable material for retaining air and smoke known to those of ordinary skill in the art. For example, the first pipe 207 can be comprised of (without being limited to) one or more of stainless steel, steel alloys, or aluminum. In some examples, the first pipe 207 further comprises at least one insulation layer (e.g., on an outer surface of first pipe 207) configured to retain heat inside the first pipe 207. The insulation layer(s) can be comprised of any suitable material known to those of ordinary skill in the art. For example, the insulation layer(s) can be comprised of (without being limited to) one or more of fiberglass, carbon fiber, or ceramic fiber. The at least one insulation layer can have a thickness of about 1 inch, about 2 inches, about 3 inches, or any thickness therebetween.

The smoker 200 comprises a second pipe 216 that is connected to the firebox 212 at the second pipe outtake and is configured to supply air and smoke from the firebox 212 to the second cooking chamber 202. The second pipe 216 can be of any diameter large enough to allow for the flow of air and smoke and heat from the firebox 212 to the second cooking chamber 202. In a non-limiting example, the second pipe 216 can have a diameter of about 3 inches, about 4 inches, about 5 inches, about 6 inches, about 7 inches, about 8 inches, about 9 inches, about 10 inches, about 11 inches, about 12 inches, or any diameter therebetween.

In some examples, the second pipe 216 is configured at an angle to assist in the flow of air and smoke from the firebox 212 to the second cooking chamber 202. In some non-limiting examples, the second pipe 216 is configured at an angle of about 1 degree, about 2 degrees, about 3 degrees, about 4 degrees, about 5 degrees, about 6 degrees, about 7 degrees, about 8 degrees, about 9 degrees, about 10 degrees, or any angle therebetween.

The second pipe 216 can be comprised of any suitable material for retaining air and smoke known to those of ordinary skill in the art. For example, the second pipe 216 can be comprised of (without being limited to) one or more of stainless steel, steel alloys, or aluminum. In some examples, the second pipe 216 further comprises at least one insulation layer (e.g., on an outer surface of second pipe 216) configured to retain heat inside the second pipe 216. The insulation layer(s) can be comprised of any suitable material known to those of ordinary skill in the art. For example, the insulation layer(s) can be comprised of (without being limited to) one or more of fiberglass, carbon fiber, or ceramic fiber. In a non-limiting example, the insulation layer(s) can have a thickness of about 1 inch, about 2 inches, about 3 inches, or any thickness therebetween.

The smoker 200 further comprises a first pipe valve (not shown) operably connected to the first pipe 207 configured to adjust the flow of air and smoke from the firebox 212 to the first cooking chamber 201 and to regulate the internal temperature of the first cooking chamber 201. The first pipe valve (not shown) is similar to second pipe valve 208 (best seen in FIG. 2B), except that the first pipe valve may be connected to the first pipe 207 on a location accessible (for example) from the back side of smoker 200. The first pipe valve can be any suitable valve known to those of ordinary skill in the art. For example, the first pipe valve can be (without being limited to) a damper valve.

In some examples, the first pipe valve comprises a display to provide the position of the first pipe valve, where the position of the first pipe valve is an indication of the amount of air and smoke flow into the first cooking chamber 201. In some examples, the first pipe valve comprises a user interface device configured to allow a user to adjust the position of the first pipe valve.

The smoker 200 further comprises a second pipe valve 208 operably connected to the second pipe 216 configured to adjust the flow of air and smoke from the firebox 212 to the second cooking chamber 202 and to regulate the internal temperature of the second cooking chamber 202. The second pipe valve 208 can be any suitable valve known to those of ordinary skill in the art. For example, the second pipe valve 208 can be (without being limited to) a damper valve.

In some examples, the second pipe valve 208 comprises a display to provide the position of the second pipe valve 208, where the position of the second pipe valve 208 is an indication of the amount of air and smoke flow into the second cooking chamber 202. In some examples, the second pipe valve 208 comprises a user interface device configured to allow a user to adjust the position of the second pipe valve 208.

In some examples, the smoker 200 comprises a first pipe splitter 209 configured to receive air and smoke flow from the first pipe 207 and to allow for the flow of air and smoke in a plurality of directions. In some examples, the first pipe splitter 209 further comprises a first plurality of funnels 210, wherein each of the first plurality of funnels 210 is configured to direct the flow of air and smoke from the first pipe 207 to at least one first outtake pipe 211. The first plurality of funnels 210 can generally comprise any suitable number of funnels. For example, the first plurality of funnels 210 can comprise, without being limited to, 1, 2, 3, 4, 5, or 6 funnels.

In some examples, the first pipe splitter 209 further comprises a first plurality of sheets configured at an angle to direct air and smoke from the first pipe 207 to the first plurality of funnels 210. In a non-limiting example, the first plurality of sheets is comprised of stainless steel. In some non-limiting examples, each of the first plurality of sheets is configured at an angle of about 1 degree, about 2 degrees, about 3 degrees, about 4 degrees, about 5 degrees, about 6 degrees, about 7 degrees, about 8 degrees, about 9 degrees, about 10 degrees, about 15 degrees, about 20 degrees, about 25 degrees, about 30 degrees, about 35 degrees, about 40 degrees, about 45 degrees, about 50 degrees, about 60 degrees, about 65 degrees, about 70 degrees, or any angle therebetween.

In some examples, the smoker 200 comprises a second pipe splitter 217 configured to receive air and smoke flow from the second pipe 216 and to allow for the flow of air and smoke in a plurality of directions. In some examples, the second pipe splitter 217 further comprises a second plurality of funnels 218, wherein each of the second plurality of funnels 218 is configured to direct the flow of air and smoke from the second pipe 216 to at least one second outtake pipe 219. The second plurality of funnels 218 can generally comprise any suitable number of funnels. For example, the second plurality of funnels 218 can comprise, without being limited to, 1, 2, 3, 4, 5, or 6 funnels.

In some examples, the second pipe splitter 217 further comprises a second plurality of sheets configured at an angle to direct air and smoke from the second pipe 216 to the second plurality of funnels 218. In a non-limiting example, the second plurality of sheets is comprised of stainless steel. In some non-limiting examples, each of the second plurality of sheets is configured at an angle of about 1 degree, about 2 degrees, about 3 degrees, about 4 degrees, about 5 degrees, about 6 degrees, about 7 degrees, about 8 degrees, about 9 degrees, about 10 degrees, about 15 degrees, about 20 degrees, about 25 degrees, about 30 degrees, about 35 degrees, about 40 degrees, about 45 degrees, about 50 degrees, about 60 degrees, about 65 degrees, about 70 degrees, or any angle therebetween.

In some examples, each of the first outtake pipe(s) 211 have a smaller diameter than the first pipe 207. In some examples, each of the first outtake pipe(s) 211 have the same diameter. In a non-limiting example, each of the first outtake pipe(s) 211 can have a diameter of about 1 inch, about 2 inches, about 3 inches, about 4 inches, about 5 inches, about 6 inches, or any diameter therebetween. There can generally be any number of the first outtake pipe(s) 211. For example, the number of the first outtake pipe(s) 211 can be, without being limited to, 1, 2, 3, 4, 5, 6, 7, or 8 pipes.

In some examples, each of the first outtake pipe(s) 211 is configured at an angle to assist in the flow of air and smoke to the first cooking chamber 201. In some non-limiting examples, each of the first outtake pipe(s) 211 is configured at an angle of about 1 degree, about 2 degrees, about 3 degrees, about 4 degrees, about 5 degrees, about 6 degrees, about 7 degrees, about 8 degrees, about 9 degrees, about 10 degrees, or any angle therebetween.

Each of the first outtake pipe(s) 211 can be comprised of any suitable material known to those of ordinary skill in the art. For example, each of the first outtake pipe(s) 211 can be comprised of (without being limited to) one or more of stainless steel, steel alloys, or aluminum. In some examples, each of the first outtake pipe(s) 211 further comprises at least one insulation layer (e.g., on an outer surface) configured to retain heat inside each of the first outtake pipe(s) 211. The insulation layer(s) can be comprised of any suitable material known to those of ordinary skill in the art. For example, the insulation layer(s) can be comprised of (without being limited to) one or more of fiberglass, carbon fiber, or ceramic fiber. In a non-limiting example, the insulation layer(s) can have a thickness of about 1 inch, about 2 inches, about 3 inches, or any thickness therebetween.

In some examples, each of the second outtake pipe(s) 219 have a smaller diameter than the first pipe 207. In some examples, each of the second outtake pipe(s) 219 have the same diameter. In a non-limiting example, each of the at second outtake pipe(s) 219 can have a diameter of about 1 inch, about 2 inches, about 3 inches, about 4 inches, about 5 inches, about 6 inches, or any diameter therebetween. There can generally be any number of the second outtake pipe(s) 219. For example, the number of the second outtake pipe(s) 219 can be, without being limited to, 1, 2, 3, 4, 5, 6, 7, or 8 pipes.

In some examples, each of the second outtake pipe(s) 219 is configured at an angle to assist in the flow of air and smoke to the second cooking chamber 202. In some non-limiting examples, each of the second outtake pipe(s) 219 is configured at an angle of about 1 degree, about 2 degrees, about 3 degrees, about 4 degrees, about 5 degrees, about 6 degrees, about 7 degrees, about 8 degrees, about 9 degrees, about 10 degrees, or any angle therebetween.

Each of the second outtake pipe(s) 219 can be comprised of any suitable material known to those of ordinary skill in the art. For example, each of the second outtake pipe(s) 219 can be comprised of (without being limited to) one or more of stainless steel, steel alloys, or aluminum. In some examples, each of the second outtake pipe(s) 219 further comprises at least one insulation layer (e.g., on an outer surface) configured to retain heat inside each of the second outtake pipe(s) 219. The insulation layer(s) can be comprised of any suitable material known to those of ordinary skill in the art. For example, the insulation layer(s) can be comprised of (without being limited to) one or more of fiberglass, carbon fiber, or ceramic fiber. In a non-limiting example, the insulation layer(s) can have a thickness of about 1 inch, about 2 inches, about 3 inches, or any thickness therebetween.

In some examples, each of the first outtake pipe(s) 211 is connected to the first cooking chamber 201 at a position adjacent to the bottom surface of the first cooking chamber 201. In some examples, each of the first outtake pipe(s) 211 is connected to the first cooking chamber 201 at a position adjacent to each of the bottom corners of the first cooking chamber 201. Through connecting each of the first outtake pipe(s) 211 at each of the bottom corners of the first cooking chamber 201, the first cooking chamber 201 receives an equal amount of air and smoke from the firebox 212 throughout the first cooking chamber 201. This assists in ensuring a uniform temperature throughout the first cooking chamber 201.

The first cooking chamber 201 comprises a first cooking chamber door 203 configured to move from a closed position to an open position. The first cooking chamber door 203 is configured to allow for the insertion of raw food onto one of a first plurality of cooking trays 226 when in the open position. The first cooking chamber 201 can be comprised of any suitable material configured to retain heat known to those of ordinary skill in the art. For example, the first cooking chamber 201 can be comprised of (without being limited to) one or more of stainless steel, steel alloys, aluminum, or cast iron.

In some examples, the first cooking chamber 201 further comprises at least one insulation layer configured to retain heat inside the first cooking chamber 201. In some examples, the first cooking chamber 201 comprises two insulation layers, with one insulation layer positioned on the inner surface of the first cooking chamber 201 and one insulation layer positioned on the outer surface of the first cooking chamber 201. Each of the insulation layer(s) can be comprised of any suitable material known to those of ordinary skill in the art. For example, the insulation layer(s) can be comprised of (without being limited to) one or more of fiberglass, carbon fiber, or ceramic fiber. In a non-limiting example, each of the insulation layer(s) can have a thickness of about 1 inch, about 2 inches, about 3 inches, or any thickness therebetween.

The first cooking chamber 201 further comprises at least one first thermometer configured to measure at least one temperature inside the first cooking chamber 201. The first thermometer(s) may be of any suitable type known to those of ordinary skill in the art. In some examples, the first thermometer(s) can be configured to transmit temperature measurements to a display device by a wired or a wireless connection, such as through a network, WiFi, or Bluetooth connection. In some examples, at least one of the first thermometer(s) is a first temperature gauge 225. In some examples, the first temperature gauge 225 is positioned on the first cooking chamber door 203.

The first cooking chamber 201 comprises a first plurality of cooking trays 226. In some examples, the first plurality of cooking trays 226 are positioned in vertical rows within the first cooking chamber 201. In some examples, the first plurality of cooking trays 226 can be removed for cleaning. In some examples, the first plurality of cooking trays 226 are configured at an angle to allow for waste, such as grease, to flow off the first plurality of cooking trays 226 to the bottom surface of the first cooking chamber 201. In some examples, the first plurality of cooking trays 226 are comprised of a mesh material configured to allow for waste, such as grease, to fall to the bottom surface of the first cooking chamber 201. The first plurality of cooking trays 226 can be comprised of any suitable material known to those of ordinary skill in the art. For example, the first plurality of cooking trays 226 can be comprised of (without being limited to) one or more of stainless steel, steel alloys, or aluminum.

The first cooking chamber 201 comprises a first waste pipe (not shown, but similar to second waste pipe 220 shown in FIG. 2C) configured to allow for the removal of waste from the first cooking chamber 201. In some examples, the first waste pipe is connected to the bottom surface of the first cooking chamber 201. In some examples, the bottom surface of the first cooking chamber 201 is configured at a slope, wherein the first waste pipe is positioned at the bottom of the slope to assist in the removal of waste from the first cooking chamber 201.

The first cooking chamber 201 further comprises a first smokestack 205 configured to remove air and smoke from the first cooking chamber 201. In some examples, the first smokestack 205 is positioned on the top surface of the first cooking chamber 201. In some examples, the first smokestack 205 is positioned in the center of the top surface of the first cooking chamber 201. The combination of positioning the first smokestack 205 in the center of the top surface of the first cooking chamber 201 and connecting the first outtake pipes 211 at each of the bottom corners of the first cooking chamber 201 provides a flow of air and smoke within the first cooking chamber 201. This assists in providing a uniform temperature within the first cooking chamber 201.

The first smokestack 205 comprises a first smokestack valve 206 configured to adjust the flow of air and smoke out of the first cooking chamber 201. Through adjusting the air and smoke flow out of the first cooking chamber 201, the first smokestack valve 206 assists in controlling the internal temperature of the first cooking chamber 201. The first smokestack valve 206 can be any suitable valve known to those of ordinary skill in the art. In a non-limiting example, the first smokestack valve 206 can be a damper valve.

In some examples, the first smokestack valve 206 comprises a display to provide the position of first smokestack valve 206, where the position of the first smokestack valve 206 is an indication of the amount of air and smoke flow out of the first cooking chamber 201. In some examples, the first smokestack valve 206 comprises a user interface device configured to allow a user to adjust the position of the first smokestack valve 206.

In some examples, each of the second outtake pipe(s) 219 is connected to the second cooking chamber 202 at a position adjacent to the bottom surface of the second cooking chamber 202. In some examples, each of the second outtake pipe(s) 219 is connected to the second cooking chamber 202 at a position adjacent to each of the bottom corners of the second cooking chamber 202. Through connecting each of the second outtake pipe(s) 219 at each of the bottom corners of the second cooking chamber 202, the second cooking chamber 202 receives an equal amount of air and smoke from the firebox 212 throughout the second cooking chamber 202. This assists in ensuring a uniform temperature throughout the second cooking chamber 202.

The second cooking chamber 202 comprises a second cooking chamber door 204 configured to move from a closed position to an open position. The second cooking chamber door 204 is configured to allow for the insertion of raw food onto one of a second plurality of cooking trays 228 when in the open position. The second cooking chamber 202 can be comprised of any suitable material configured to retain heat known to those of ordinary skill in the art. For example, the second cooking chamber 202 can be comprised of (without being limited to) one or more of stainless steel, steel alloys, aluminum, or cast iron.

In some examples, the second cooking chamber 202 further comprises at least one insulation layer configured to retain heat inside the second cooking chamber 202. In some examples, the second cooking chamber 202 comprises two insulation layers, with one insulation layer positioned on the inner surface of the second cooking chamber 202 and one insulation layer positioned on the outer surface of the second cooking chamber 202. Each of the insulation layer(s) can be comprised of any suitable material known to those of ordinary skill in the art. For example, the insulation layer(s) can be comprised of (without being limited to) one or more of fiberglass, carbon fiber, or ceramic fiber. In a non-limiting example, each of the insulation layer(s) can have a thickness of about 1 inch, about 2 inches, about 3 inches, or any thickness therebetween.

The second cooking chamber 202 further comprises at least one second thermometer configured to measure at least one temperature inside the second cooking chamber 202. The second thermometer(s) may be of any suitable type known to those of ordinary skill in the art. In some examples, the second thermometer(s) can be configured to transmit temperature measurements to a display device by a wired or a wireless connection, such as through a network, WiFi, or Bluetooth connection. In some examples, at least one of the second thermometer(s) is a second temperature gauge 227. In some examples, the second temperature gauge 227 is positioned on the second cooking chamber door 204.

The second cooking chamber 202 comprises a second plurality of cooking trays 228. In some examples, the second plurality of cooking trays 228 are positioned in vertical rows within the second cooking chamber 202. In some examples, the second plurality of cooking trays 228 can be removed for cleaning. In some examples, the second plurality of cooking trays 228 are configured at an angle to allow for waste, such as grease, to flow off the second plurality of cooking trays 228 to the bottom surface of the second cooking chamber 202. In some examples, the second plurality of cooking trays 228 are comprised of a mesh material configured to allow for waste, such as grease, to fall to the bottom surface of the second cooking chamber 202. The second plurality of cooking trays 228 can be comprised of any suitable material known to those of ordinary skill in the art. For example, each of the second plurality of cooking trays 228 can be comprised of (without being limited to) one or more of stainless steel, steel alloys, or aluminum.

The second cooking chamber 202 comprises a second waste pipe 220 configured to allow for the removal of waste from the second cooking chamber 202. In some examples, the second waste pipe 220 is connected to the bottom surface of the second cooking chamber 202. In some examples, the bottom surface of the second cooking chamber 202 is configured at a slope, wherein the second waste pipe 220 is positioned at the bottom of the slope to assist in the removal of waste from the second cooking chamber 202.

The second cooking chamber 202 further comprises a second smokestack 214 configured to remove air and smoke from the second cooking chamber 202. In some examples, the second smokestack 214 is positioned on the top surface of the second cooking chamber 202. In some examples, the second smokestack 214 is positioned in the center of the top surface of the second cooking chamber 202. The combination of positioning the second smokestack 214 in the center of the top surface of the second cooking chamber 202 and connecting the second outtake pipe(s) 219 at each of the bottom corners of the second cooking chamber 202 provides a flow of air and smoke within the second cooking chamber 202. This assists in providing a uniform temperature within the second cooking chamber 202.

The second smokestack 214 comprises a second smokestack valve 215 configured to adjust the flow of air and smoke out of the second cooking chamber 202. Through adjusting the air and smoke flow out of the second cooking chamber 202, the second smokestack valve 215 assists in controlling the internal temperature of the second cooking chamber 202. The second smokestack valve 215 can be any suitable valve known to those of ordinary skill in the art. In a non-limiting example, the second smokestack valve 215 can be a damper valve.

In some examples, the second smokestack valve 215 comprises a display to provide the position of second smokestack valve 215, where the position of the second smokestack valve 215 is an indication of the amount of air and smoke flow out of the second cooking chamber 202. In some examples, the second smokestack valve 215 comprises a user interface device configured to allow a user to adjust the position of the second smokestack valve 215.

In some examples, the first pipe 207, the first pipe splitter 209, the first plurality of funnels 210 and the first outtake pipes 211 may form a first set of conduits configured to supply a flow of air and smoke from the firebox 212 to the first cooking chamber 201. Similarly, the second pipe 216, the second pipe splitter 217, the second plurality of funnels 218 and the second outtake pipe(s) 219 may form a second set of conduits configured to supply a flow of air and smoke from the firebox 212 to the second cooking chamber 202.

In some examples, smoker 200 may include two cooking systems. The first cooking system may include the first cooking chamber 201, the first smokestack 205, the first set of conduits (between the first cooking chamber 201 and the firebox 212) together with the first pipe valve and the first smokestack valve 206. In some examples, the combination of the first pipe valve and the first smokestack valve 206 may be configured to facilitate adjustable internal temperature regulation of the first cooking chamber 201. Similarly, the second cooking system may include the second cooking chamber 202, the second smokestack 214, the second set of conduits (between the second cooking chamber 202 and the firebox 212) together with the second pipe valve 208 and the second smokestack valve 215. In some examples, the combination of the second pipe valve 208 and the second smokestack valve 215 may be configured to facilitate adjustable internal temperature regulation of the second cooking chamber 202. In this manner, the first combination of the first pipe valve, the first smokestack valve 206 and the first temperature gauge 225 together with the second combination of the second pipe valve 208, the second smokestack valve 215 and the second temperature gauge 227 cooperate to facilitate independent and adjustable temperature regulation for each of the first and second cooking systems.

Accordingly, the first cooking system may be used independently from the second cooking system and may also be used at different times. For example, the first cooking system may be used to cook lunch at a first time and the second cooking system may be used to cook dinner at a second later time. Another advantage of the smoker 200 is the ability to keep food separate for allergy or religious reasons, or the like.

In some examples, smoker 200 may include two or more cooking chambers (i.e., the first cooking chamber 201 and the second cooking chamber 202), where both cooking chambers are configured to have a similar and/or a same size. For example, as shown best in FIGS. 2A, 2B and 2D, the first cooking chamber 201 is configured to be a same size as the second cooking chamber 202. In some examples, the two cooking chambers may be configured to have different sizes. For example, the first cooking chamber 201 may be configured to be larger than (i.e., have a greater internal volume the second cooking chamber 202 (e.g., as illustrated by the first cooking chamber 101 and the second cooking chamber 102 of smoker 100, shown best in FIGS. 1A, 1B and 1D). Although FIGS. 2A-2D illustrate two cooking chambers, smoker 200 is not so limited and may include, in some examples, more than two cooking chambers (e.g., by incorporating a suitable set of conduits), to thereby provide more than two cooking systems.

What is claimed is:

1. A smoker comprising:
a firebox; and
a plurality of cooking systems, wherein each cooking system of the plurality of cooking systems comprises:
a cooking chamber connected to the firebox by a set of conduits, the set of conduits configured to supply a flow of air and smoke from the firebox to the cooking chamber;
a valve operably connected to the set of conduits configured to adjust the flow of air and smoke to the cooking chamber; and
a smokestack connected to the cooking chamber configured to allow the flow of air and smoke to exit the cooking chamber.

2. The smoker of claim 1, wherein each cooking system further comprises an additional valve operably connected to the smokestack and configured to adjust the flow of air and smoke that exits the cooking chamber.

3. The smoker of claim 2, wherein the valve and the additional valve cooperate to facilitate independent and adjustable temperature regulation for each of the plurality of cooking systems.

4. The smoker of claim 1, wherein each cooking system further comprises at least one thermometer configured to measure an internal temperature of the cooking chamber.

5. The smoker of claim 1, wherein the cooking chamber comprises a top surface, a bottom surface and one or more side surfaces, the set of conduits being connected to the cooking chamber on at least one of the one or more side surfaces at one or more positions that are adjacent to the bottom surface.

6. The smoker of claim 1, wherein the cooking chamber comprises a top surface, a bottom surface and one or more side surfaces, the set of conduits comprise:
a pipe splitter;
a first pipe connected to the firebox and the pipe splitter; and
a plurality of second pipes connected to the pipe splitter and the cooking chamber at a plurality of positions on the one or more side surfaces.

7. The smoker of claim 1, wherein the cooking chamber comprises a top surface, a bottom surface and one or more side surfaces, the set of conduits comprise:
a first pipe splitter;
two or more second pipe splitters;
a first pipe connected to the firebox and the first pipe splitter;
two or more second pipes connected to the first pipe splitter and the two or more second pipe splitters; and
a plurality of third pipes connected to the two or more second pipe splitters and the cooking chamber at a plurality of positions on the one or more side surfaces.

8. The smoker of claim 1, wherein the cooking chamber of each of the plurality of cooking systems comprises a same size.

9. The smoker of claim 1, wherein the cooking chamber of at least one among the plurality of cooking systems comprises a different size.

10. The smoker of claim 1, wherein the cooking chamber comprises a top surface, a bottom surface and one or more side surfaces, the smokestack being positioned on the top surface of the cooking chamber.

11. The smoker of claim 1, wherein each cooking system of the plurality of cooking systems comprises a waste pipe connected to the cooking chamber configured to facilitate removal of waste from the cooking chamber.

12. The smoker of claim 1, wherein each cooking system further comprises a plurality of vertically spaced cooking trays mounted in an interior of the cooking chamber.

13. A smoker comprising:
a firebox;
a first cooking chamber connected to the firebox by a first set of conduits, the first set of conduits configured to direct a flow of air and smoke from the firebox to the first cooking chamber;
a second cooking chamber connected to the firebox by a second set of conduits, the second set of conduits configured to direct the flow of air and smoke from the firebox to the second cooking chamber; and
a first valve and a second valve operably connected to the respective first set of conduits and the second set of conduits, the first valve and the second valve configured to independently adjust the flow of air and smoke supplied to the first cooking chamber and the second cooking chamber from the firebox.

14. The smoker of claim 13, wherein the first cooking chamber and the second cooking chamber comprise a same size.

15. The smoker of claim 13, wherein the first cooking chamber and the second cooking chamber comprises different sizes.

16. The smoker of claim 13, further comprising:
a first smokestack connected to a top surface of the first cooking chamber configured to allow the flow of air and smoke to exit the first cooking chamber; and
a second smokestack connected to a top surface of the second cooking chamber configured to allow the flow of air and smoke to exit the second cooking chamber.

17. The smoker of claim 16, further comprising a first additional valve and a second additional valve operably connected to the first smokestack and the second smokestack configured to independently adjust the flow of air and smoke that exits the respective first smokestack and the second smokestack.

18. The smoker of claim 16, wherein:
the first smokestack is connected at a center of the top surface of the first cooking chamber, and
the second smokestack is connected at a center of the top surface of the second cooking chamber.

19. The smoker of claim 13, wherein the first set of conduits and the second set of conduits are positioned below the first cooking chamber and the second cooking chamber and adjacent to the firebox.

20. The smoker of claim 13, wherein each of the first cooking chamber and the second cooking chamber comprises a top surface, a bottom surface, and one or more side surfaces, each of the first set of conduits and the second set of conduits are configured to be connected to the respective first cooking chamber and the second cooking chamber on at least one of the one or more side surfaces at one or more positions that are adjacent to the bottom surface.
